(19) United States
(12) Patent Application Publication
(10) Pub. No.: US 2007/0191009 A1
(43) Pub. Date: Aug. 16, 2007

(54) Method for performing a handover in a communication system

(75) Inventors: Eun-Sil Hong, Suwon-si (KR); Hyon-Goo Kang, Suwon-si (KR); Joong-Keun Cho, Suwon-si (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 11/653,794

(22) Filed: Jan. 16, 2007

(30) Foreign Application Priority Data
Jan. 13, 2006 (KR) 2006-4145

(51) Int. Cl. H04Q 7/20

(52) U.S. Cl. 455/436

(57) ABSTRACT

Disclosed is a method for performing a handover in a communication system, comprising causing the MS to receive a ranging code including the information on a handover bandwidth request ranging code from a serving BS, the handover bandwidth request ranging code being used for the MS to get an uplink bandwidth required for the handover allocated by the serving BS in a contention-free scheme, and causing the MS to request the serving BS to allocate the uplink bandwidth for the handover by using the handover bandwidth request ranging code.

### PRIORITY

This application claims priority under 35 U.S.C. § 119 to an application filed in the Korean Intellectual Property Office on Jan. 13, 2006 and assigned Serial No. 2006-4145, the contents of which are incorporated herein by reference.

### BACKGROUND OF THE INVENTION

1. Field of the Invention

The present invention relates to a communication system, and more particularly to a method for performing a handover in a communication system.

2. Description of the Related Art

A great amount of research has been conducted for communication systems of the next generation to provide users with high speed communication services with various quality of service (QoS). A typical communication system for the next generation is one proposed by IEEE (Institute of Electrical and Electronics Engineers) 802.16e, whose structure is described herein in connection with the schematic diagram of FIG. 1.

The IEEE 802.16e communication system is a multi-cell structure, which comprises cells 100, 150, respective base stations (BSs) 110, 140 for controlling cells 100 and 150, and a plurality of mobile stations (MSs) 111, 113, 130, 151, 153. Referring to FIG. 1, MS 130, existing in an overlapping cell region, has a high probability of being handed over. It is assumed that the base station 110 is presently serving the MS 130, and the base station 140 is a target base station where the MS will be handed over.

Referring to FIG. 2, which illustrates the process of handover the MS in a typical IEEE 802.16e communication system, the MS 130 presently communicating with the BS 110 must send a mobile handover request message (MOB_MSHO-REQ) to the BS 110 if it detects the necessity of being handed over to another BS. To this end, the MS 130 sends a bandwidth request CDMA (Code Division Multiple Access) code through a ranging channel to the presently serving BS 110 in order to request allocation of an uplink bandwidth for transmitting the MOB_MSHO-REQ message in step 211. The terms “CDMA code” and “ranging code” mentioned hereinafter refer to the same code, differing only in name.

The conventional IEEE 802.16e communication system provides a plurality of ranging codes that are classified so as to be used for ranging purposes. For example, ranging codes of the IEEE 802.16e communication system consist of initial ranging codes, bandwidth request ranging codes, periodic ranging codes, and handover ranging codes according to the ranging purpose, from which the MS selects a particular one proper for its purpose. Hence, the MS 130 selects one of the bandwidth request ranging codes to send a bandwidth request message to the BS 110 in step 211. In this case, the bandwidth request of the MS 130 is contention-based.

Receiving the bandwidth request ranging code from the MS 130, the BS 110 determines to allocate an uplink bandwidth for the MS 130, and sends a CDMA allocation IE (Information Element) containing the information on the uplink bandwidth to be allocated to the MS 130 in step 213. In this case, the CDMA allocation IE (CDMA_Allocation_IE) is carried on an uplink MAP (UL-MAP) message, containing the uplink bandwidth to be allocated, the bandwidth request ranging code having been sent from the MS 130 to the BS 110, and the ranging channel information. Thus, the MS 130 recognizes the uplink bandwidth allocated for it by detecting the bandwidth request ranging code and ranging channel information contained in the CDMA allocation IE.

Then the MS 130 sends a bandwidth request header (BRH) for requesting allocation of an additional uplink bandwidth through the uplink bandwidth previously allocated to the BS 110 in step 215. In this case, the BRH includes a connection identifier (ID) (CID) for requesting allocation of an additional uplink bandwidth, and information on the uplink bandwidth actually required. Receiving the BRH from the MS 130, the BS 110 allocates an addition uplink bandwidth for the MS 130, and sends the UL-MAP message containing the information on the additional uplink bandwidth to the MS 130 in step 217.

Receiving the UL-MAP message from the BS 130, the MS 130 detects the additional uplink bandwidth to send the MOB_MSHO-REQ message in step 219. The MOB_MSHO-REQ message contains a BS ID list of the IDs of the adjacent BSs that may be targeted for handing over the MS 130. Then the BS 130 sends a BS handover response (MOB_BSHO-RSP) message to the MS 130 in response to the MOB_MSHO-REQ message in step 221. The MOB_BSHO-RSP message includes a BS ID list of the IDs of the adjacent BSs recommended by the BS 110 to hand over the MS 130.

Receiving the MOB_BSHO-RSP message, the MS 130 must send a mobile station handover indication (MOB_HO-IND) message for informing the BS 110 that it will be finally handed over. Hence, the MS 130 sends another bandwidth request ranging code through a ranging channel to the BS 110 in order to request allocation of another uplink bandwidth for transmitting the MOB_HO-IND message in step 223.

Receiving the bandwidth request ranging code from the MS 130, the BS 110 determines to allocate an uplink bandwidth for the MS 130, and sends a CDMA allocation IE containing the information on the uplink bandwidth to be allocated to the MS 130 in step 225. Then the MS 130 sends a BRH for requesting allocation of an additional uplink bandwidth through the uplink bandwidth previously allocated to the BS 110 in step 227. Receiving the BRH from the MS 130, the BS 110 allocates an addition uplink bandwidth for the MS 130, and sends the UL-MAP message containing the information on the additional uplink bandwidth to the MS 130 in step 229.

Receiving the UL-MAP message from the BS 110, the MS 130 detects the additional uplink bandwidth to send the MOB_HO-IND message in step 231. In this case, the MOB_HO-IND message contains the ID of the BS targeted for the MS 130 to be handed over.

As described above in connection with FIG. 2, the MS 130 must get an uplink bandwidth allocated for transmitting the MBO_MSHO-REQ message and the MOB_HO-IND message in order to be handed over. However, the allocation of the uplink bandwidth is performed in contention-based scheme, thereby resulting in a delay of the bandwidth request time T_bwreq. The delay of T_bwreq shown in FIG. 2 is the minimum, which increases due to the collision of the bandwidth request ranging code when other MSs also use the same bandwidth request ranging code as the MS 130.

Moreover, the channel state between the MS 130 and the BS 110 becomes very poor when performing the handover, the delay of T_bwreq for allocating the uplink bandwidth causes the MBO_MSHO-REQ and MOB_HO-IND messages to be delayed, so that the handover itself may result in delayed communication services, and also makes it impossible the transmission itself of the MBO_MSHO-REQ and MOB_HO-IND messages, thereby degrading the QoS.

### SUMMARY OF THE INVENTION

It is an object of the present invention to provide a method for performing a handover in a communication system.

It is another object of the present invention to provide a method for performing a handover by allocating an uplink bandwidth in a contention-free scheme in a communication system.

According to an aspect of the present invention, a method for performing a handover in a communication system, comprises causing the MS to receive a ranging code containing information on a handover bandwidth request ranging code from a serving BS, the handover bandwidth request ranging code being used for the MS to get an uplink bandwidth required for the handover allocated by the serving BS in a contention-free scheme, and causing the MS to request the serving BS to allocate the uplink bandwidth for the handover by using the handover bandwidth request ranging code.

### BRIEF DESCRIPTION OF THE DRAWINGS

The above and other objects, features and advantages of the present invention will become more apparent from the following detailed description when taken in conjunction with the accompanying drawing in which:

FIG. 1 is a schematic diagram illustrating the structure of an IEEE 802.16e communication system;

FIG. 2 is a flowchart illustrating the process of handing over a mobile station in a conventional IEEE 802.16e communication system;

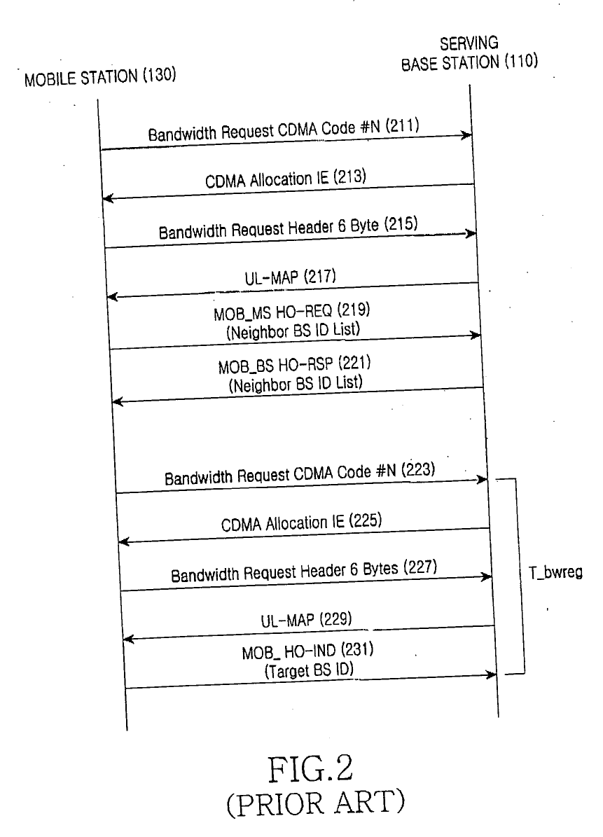

FIG. 3 is a flowchart illustrating the process of handing over a mobile station in an IEEE 802.16e communication system according to the present invention; and

FIG. 4 is a flowchart illustrating the process of operating the MS 130 of FIG. 3.

### DETAILED DESCRIPTION OF THE PREFERRED EMBODIMENT

Preferred embodiments of the present invention will be described herein below with reference to the accompanying drawings. In the drawings, the same or similar elements are denoted by the same reference numerals even though they are depicted in different drawings. In the following description, well-known functions or constructions are not described in detail since they would obscure the invention in unnecessary detail.

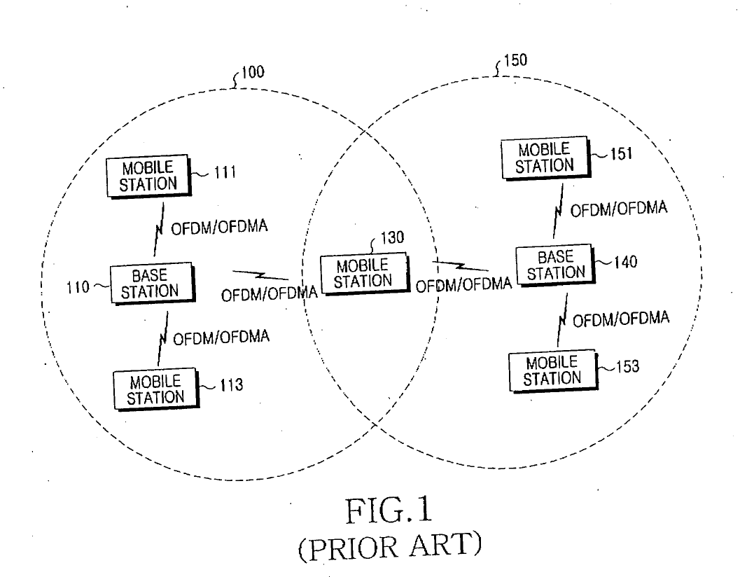

The present invention provides a system and method for performing a handover by allocating an uplink bandwidth for a mobile station (MS) in a contention-free scheme. Hereinafter, an Institute of Electrical and Electronics Engineers (IEEE) 802.16e communication system is employed to describe the invention. The structure of this communication system is as shown in FIG. 1.

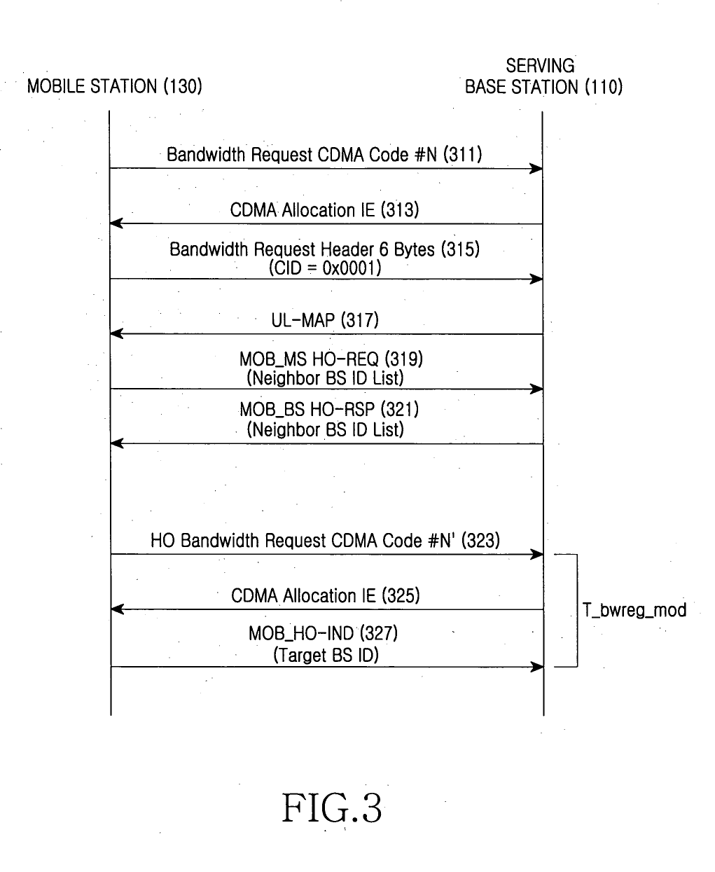

Referring to FIG. 3, the MS 130 presently communicating with a base station (BS) 110 must send a mobile handover request message (MOB_MSHO-REQ) to the BS 110 if it detects the necessity of being handed over to another BS. To this end, the MS 130 sends a bandwidth request code division multiple access (CDMA) code through a ranging channel to the presently serving BS 110 in order to request allocation of an uplink bandwidth for transmitting the MOB_MSHO-REQ message in step 311. The terms “CDMA code” and “ranging code” mentioned hereinafter refers to the same code, differing only in name.

The IEEE 802.16e communication system provides a plurality of ranging codes that are classified so as to be used for the ranging purpose. For example, the ranging codes of the IEEE 802.16e communication system consist of initial ranging codes, bandwidth request ranging codes, periodic ranging codes, and handover ranging codes according to the ranging purpose, from which the MS selects a particular one proper for its purpose. In the present invention, the classification further includes handover bandwidth request (HO BW-REQ) ranging codes for requesting allocation of an uplink bandwidth for transmitting a handover indication (MOB_HO-IND) message in addition to those conventional ranging codes described above. Namely, the handover bandwidth request ranging code is a ranging code for requesting the BS to allocate an uplink bandwidth in a contention-free scheme for the MS to transmit the MOB_HO-IND message. The serving BS 110 also sends the information on those ranging codes through an uplink channel descriptor (UCD) message to the MSs controlled by the serving BS 110.

In addition, the MS 130 selects one of the bandwidth request ranging codes to send a bandwidth request message to the BS 110 in step 311. In this case, the bandwidth request of the MS 130 is contention-based.

Receiving the bandwidth request ranging code from the MS 130, the BS 110 determines to allocate an uplink bandwidth for the MS 130, and sends a CDMA allocation IE (Information Element) containing the information on the uplink bandwidth to be allocated to the MS 130 in step 313. In this case, the CDMA allocation IE is carried on an uplink MAP (UL-MAP) message, containing the uplink bandwidth to be allocated, the bandwidth request ranging code having been sent from the MS 130 to the BS 110, and the ranging channel information. Thus, the MS 130 recognizes the uplink bandwidth allocated for it by detecting the bandwidth request ranging code and ranging channel information contained in the CDMA allocation IE.

Then the MS 130 sends a bandwidth request header (BRH) for requesting allocation of an additional uplink bandwidth through the uplink bandwidth previously allocated to the BS 110 in step 315. In this case, the BRH includes a connection identifier (ID)(CID) for requesting allocation of an additional uplink bandwidth, and information on the uplink bandwidth actually required. Receiving the BRH from the MS 130, the BS 110 allocates an additional uplink bandwidth for the MS 130, and sends the UL-MAP message containing the information on the additional uplink bandwidth to the MS 130 in step 317.

Receiving the UL-MAP message from the BS 130, the MS 130 detects the additional uplink bandwidth to send the MOB_MSHO-REQ message in step 319. The MOB_MSHO-REQ message contains a BS ID list of the IDs of the adjacent BSs that may be targeted for handing over the MS 130. Then the BS 130 sends a MOB_BSHO-RSP message to the MS 130 in response to the MOB_MSHO-REQ message in step 321. The MOB_BSHO-RSP message includes a BS ID list of the IDs of the adjacent BSs recommended by the BS 110 to hand over the MS 130.

Receiving the MOB_BSHO-RSP message, the MS 130 must send a MOB_HO-IND message for informing the BS 110 that it will be finally handed over. Hence, the MS 130 sends a handover bandwidth request ranging code through a ranging channel to the BS 110 in order to request allocation of another uplink bandwidth for transmitting the MOB_HO-IND message in step 323.

Receiving the handover bandwidth request ranging code from the MS 130, the BS 110 determines to allocate an uplink bandwidth for the MS 130 to transmit the MOB_MSHO-IND message, and sends a CDMA allocation IE containing the information on the uplink bandwidth to be allocated to the MS 130 in step 325. In this case, the handover bandwidth request ranging code is a ranging code used for the MS 130 to request the BS 110 to allocate an uplink bandwidth adequate for transmitting the MOB_MSHO-IND. Then the MS 130 sends the MOB_HO-IND message through the allocated uplink bandwidth to the serving BS 110 in step 327. In this case, the MOB_HO-IND message also includes the ID of the target BS station 140 where the MS 130 is handed over.

As described above, the MS 130 employs the handover bandwidth request ranging code to obtain allocation of the uplink bandwidth for transmitting the MOB_HO-IND message in a contention-free scheme, so that the time taken for transmitting the MOB_HO-IND message is minimized, as is the service time delay owing to performing the handover. As shown in FIG. 3, the time taken for transmitting the MOB_HO-IND message is considerably reduced from T_bwreq to T_bwreq_mod.

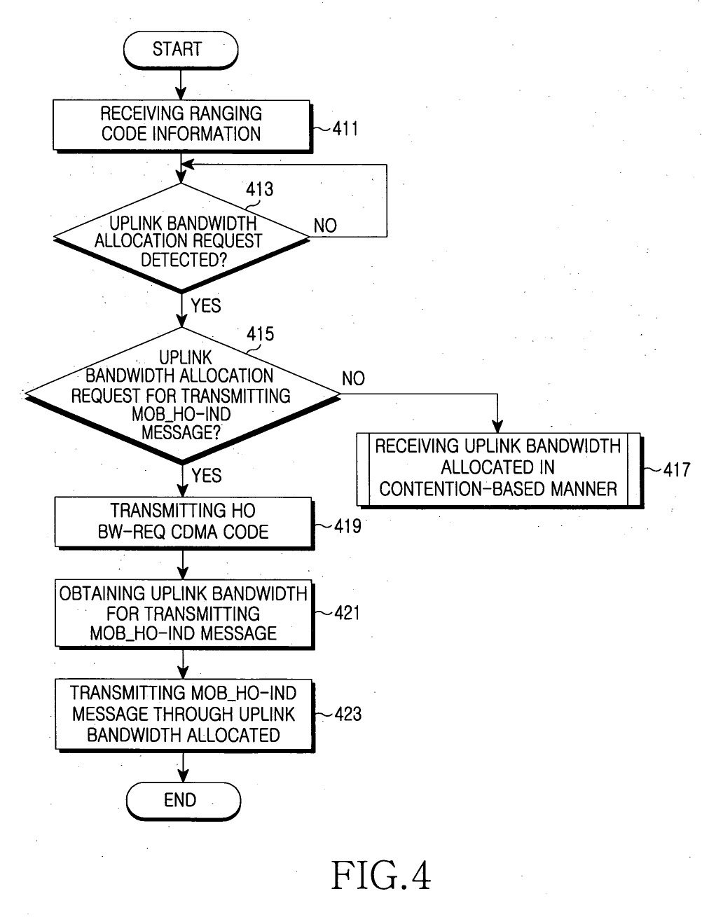

Referring to FIG. 4, which illustrates the operation of the MS 130 of FIG. 3, in step 411 the MS 130 receives the ranging code information through a UCD message from the serving BS 110, and then proceeds to step 413. In this case, the ranging code information represents the information on the initial ranging codes, bandwidth request ranging codes, periodic ranging codes, handover ranging codes, and handover bandwidth request ranging codes used for the IEEE 802.16e communication system, as described in connection with FIG. 3.

In step 413 the MS 130 determines whether there is an uplink bandwidth allocation request. If the uplink bandwidth allocation request is detected, the MS proceeds to step 415 to determine whether the uplink bandwidth allocation request is for transmitting the MOB_HO-IND message. If it is not for transmitting the MOB_HO-IND message, the MS 130 proceeds to step 417 to receive an uplink bandwidth allocated in the conventional contention-based scheme, as described above.

Alternatively, if the uplink bandwidth allocation request is for transmitting the MOB_HO-IND message in step 415, the MS 130 proceeds to step 419 to send the handover bandwidth request ranging code to the serving BS 110, and then to step 421. Obtaining allocation of the uplink bandwidth for transmitting the MOB_HO-IND message in step 421, the MS 130 proceeds to step 423. In this case, the MS 130 may comprehend the information on the uplink bandwidth allocated by the serving BS 110 through the CDMA allocation IE. In step 423 the MS 130 sends the MOB_HO-IND message through the allocated uplink bandwidth to the serving BS 110.

Thus, the invention enables the MS to obtain allocation of the uplink bandwidth for transmitting the MOB_HO-IND message in a contention-free scheme, so that the time taken for allocating the uplink bandwidth is considerably reduced, and thus the handover delay also, thereby improving the overall quality of service (QoS).

While the invention has been shown and described with reference to a certain preferred embodiment thereof, it will be understood by those skilled in the art that various changes in form and details may be made therein without departing from the spirit and scope of the invention.

What is claimed is:

1. A method for performing a handover by a mobile station (MS) in a communication system, comprising:
causing the MS to receive a ranging code including information on a handover bandwidth request ranging code from a serving base station (BS), the handover bandwidth request ranging code being used for the MS to obtain an uplink bandwidth required for the handover allocated by the serving BS in a contention-free scheme; and
causing the MS to request the serving BS to allocate the uplink bandwidth for the handover by using the handover bandwidth request ranging code.

2. The method as defined in claim 1, wherein the allocation of the uplink bandwidth is required for the MS to transmit a handover indication (MO_HO-IND) message to inform the serving BS of the MS being handed over to a target BS.

3. The method as defined in claim 2, further comprising:
causing the serving BS to allocate the uplink bandwidth to the MS according to the handover bandwidth request ranging code; and
causing the MS to transmit the MO_HO-IND message through the uplink bandwidth to the serving BS.

4. A method for performing a handover by a serving base station (BS) in a communication system, comprising:
enabling the serving BS to transmit ranging code information including the information on a handover bandwidth request ranging code to a mobile station(MS), the handover bandwidth request ranging code being used for the BS to allocate an uplink bandwidth required for the handover in a contention-free scheme.

5. The method as defined in claim 4, further comprising:
causing the serving BS to receive the handover bandwidth request ranging code from the MS after transmitting the ranging code information; and
causing the serving BS to allocate the uplink bandwidth for the MS according to the handover bandwidth request ranging code.

6. The method as defined in claim 5, wherein causing the serving BS to allocate the uplink bandwidth includes the step of allocating the uplink bandwidth required for the MS to transmit a handover indication (MO_HO-IND) message to inform the serving BS of the MS being handed over to a target BS.

7. A method of enabling a mobile station (MS) to request a base station (BS) to allocate a bandwidth in a communication system, comprising:
causing the MS to receive a CDMA (Code Division Multiple Access) code information from the BS, the CDMA code information including a bandwidth allocation CDMA code for allocating a bandwidth;
causing the MS to transmit a bandwidth request message containing the CDMA code to the BS;
causing the MS to receive a bandwidth allocation message containing information on a bandwidth allocated by the BS according to the bandwidth request message; and
causing the MS to transmit designated information through the bandwidth to the BS.

8. A method for enabling a base station (BS) to allocate a bandwidth in a communication system, comprising the steps of:
causing the BS to transmit CDMA (Code Division Multiple Access) information including a CDMA code for allocating the bandwidth to a mobile station (MS);
causing the BS to receive a bandwidth request message containing a CDMA code for requesting allocation of the bandwidth from the MS; and
causing the BS to allocate the bandwidth according to the bandwidth request message and then to transmit information on the bandwidth to the MS.
